(19) United States
(12) Patent Application Publication
(10) Pub. No.: US 2026/0339721 A1
(43) Pub. Date: Oct. 29, 2026

(54) ENHANCING DETERMINATIONS OF RUNTIME ESTIMATIONS FOR WORKLOAD PERFORMANCES USING ARTIFICIAL INTELLIGENCE

(71) Applicant: Dell Products L.P., Round Rock, TX (US)

(72) Inventors: YUNFAN HAN, Austin, TX (US); MANPREET SINGH SOKHI, Santa Clara, CA (US); HANG YU, Beijing (CN)

(21) Appl. No.: 19/190,311

(22) Filed: Apr. 25, 2025

(51) Int. Cl. G06F 9/50

(52) U.S. Cl. CPC G06F 9/5027

(57) ABSTRACT

Methods and systems for managing operation of a distributed system are disclosed. The operation may be managed by using artificial intelligence to enhance determinations of runtime estimations for performances of workloads. For performance of a workload, a trained machine learning model may be used to generate a runtime estimation. Using the runtime estimation, the performance of the workload may be done by the distributed system. The distributed system may generate rewards based on an actual runtime for completion of the performance and/or on a difference between the actual runtime and the runtime estimation. An operation of the trained machine learning model may be updated using the rewards. By updating the operation, the trained machine learning model may generate future runtime estimations that more likely match future actual runtimes.

### FIELD

Embodiments disclosed herein relate generally to managing operation of a distributed system. More particularly, embodiments disclosed herein relate to enhancing determinations of runtime estimations for workload performances using artificial intelligence.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a distributed system in accordance with an embodiment.

FIGS. 2A-2B show data flow diagrams illustrating operation of the distributed system in accordance with an embodiment.

FIGS. 3A-3B show flow diagrams illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing operation of a distributed system. The operation may be managed by using artificial intelligence to enhance determinations of runtime estimations of performance of workloads.

The determinations of the runtime estimations may be enhanced by (i) generating a workload based on a workload request from a client, (ii) generating, by a trained machine learning model and/or based on a historical workload (any portion of which is similar to the workload), a runtime estimation, (iii) initiating, using the runtime estimation and/or any number of data processing systems of the distributed system, the performance of the workload, (iv) obtaining, after completion of the performance and/or from the any number of the data processing systems, an actual runtime of the performance, (v) generating, using the actual runtime and/or the runtime estimation, rewards for the trained machine learning model, and/or (vi) using the rewards to update operation of the trained machine learning model to enhance the determination of the runtime estimation. A first reward of the rewards may be generated when the runtime estimation is an overestimate of and/or a match to the actual runtime. The second rewards may be generated when the runtime estimation is an underestimate of the actual runtime.

By enhancing the determination, the trained machine learning model may generate future runtime estimations that match future actual runtimes of future performances of future workloads. By generating, by the trained machine learning model, the future runtime estimations that match future actual runtimes, the future performances of the future workloads may be completed by the distributed system and/or the distributed system may facilitate a provisioning of desired computer implemented services.

In an embodiment, a method for managing operation of a distributed system is disclosed. The method may include: (i) identifying a workload to be performed by the distributed system, (ii) obtaining, using a trained machine learning model, a runtime estimation for performance of the workload, (iii) scheduling, using the runtime estimation and a scheduling algorithm, the performance of the workload during a future period of time to obtain a resource allocation of the distributed system and a time allocation of the distributed system, (iv) attempting, using the resource allocation and the time allocation, to perform the workload, (v) generating, in a first instance of the attempting where the performance of the workload is completed successfully, a first reward for the performance using a first reward generation algorithm, (vi) generating, in a second instance of the attempting where the performance of the workload is not completed successfully, a second reward for the performance using a second reward generation algorithm and/or (vii) using the first reward or the second reward to update the operation of the trained machine learning model to reduce a likelihood of underestimates for runtime estimations being made at future times.

The distributed system may include a plurality of data processing systems for performing workloads, the plurality of data processing systems being managed using a scheduling system that limits use of resource allocations of the data processing systems for respective performances of the workloads, and the scheduling system terminating use of the resource allocations for the performances of the workloads regardless of whether the workloads are complete when corresponding time allocations for the resource allocations are exceeded.

Obtaining, using the trained machine learning model, the runtime estimation may include performing a lookup of past performances of historical workloads to obtain the runtime estimation from the past performances of the historical workloads.

Generating the first reward may include performing a first computation to generate the first reward using (i) the runtime estimation, (ii) a first actual runtime for the completion of the performance of the workload, and/or (iii) a first expression that causes the first reward to vary inversely with a first difference between the runtime estimation and/or the first actual runtime, the runtime estimation not being less than the first actual runtime.

Generating the second reward may include performing a second computation to generate the second reward using (i) the runtime estimation, (ii) a second actual runtime, and/or (iii) a second expression that causes the second reward to vary inversely with a second difference between the runtime estimation and the second actual runtime, the runtime estimation being less than the second actual runtime.

Using the first reward or the second reward to update the operation of the trained machine learning model may include performing, using the first reward or the second reward, adjustments to weights, biases, and/or gradients of the trained machine learning model.

The adjustments may be used, using the first reward, to enforce generation of future runtime estimations that are not less than the first actual runtime.

The adjustments may be further used, using the second reward, to enforce the generation of the future runtime estimations that are greater than the second actual runtime.

Using the first reward or the second reward to update the operation of the trained machine learning model may further include performing at least one change to an action space of the trained machine learning model on which a determination of the runtime estimation is based.

The action space may include a portion of the workload, the portion comprising input data for performance of the workload, at least one task of the workload, and/or an output data of the workload.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

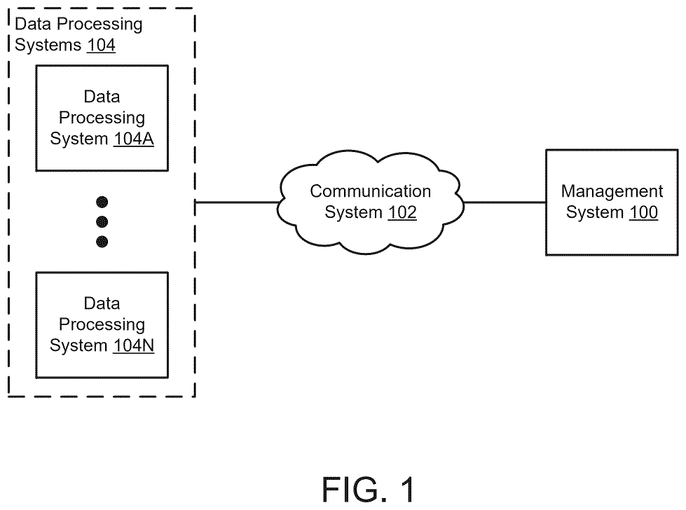

Turning to FIG. 1, a distributed system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, a performance of a workload by at least one data processing system of the distributed system may be scheduled. The workload may include at least one task related to (i) data processing, (ii) distributed simulations, (iii) hosted applications, (iv) financial transactions, etc. The performance may include running a process, by the at least one data processing system, to complete the at least one task.

The performance of the workload may be scheduled by assigning, by a scheduling algorithm of a management system, the workload to a queue. The queue may track an order for the performance of the workload. The scheduling algorithm may include (i) Slurm, (ii) Kubernetes, (iii) Grid Engine, (iv) Moab, etc. The scheduling algorithm may assign the workload based on a resource allocation and/or a time allocation. The resource allocation may include resources such as (i) available compute processing units (CPU), (ii) available graphical processing units (GPUs), (iii) available memory, and/or (iv) any other resources of the distributed system. The time allocation may include a first length of time for the resource allocation.

The scheduling algorithm may ingest a second length of the time from a client. The second length of the time may include an estimated length of the time for the performance of the workload. The client may include (i) a user, (ii) an administrator, etc. If the estimated length of the time includes an overestimated length of the time compared to an actual runtime of the performance of the workload, then at least a portion of the resource allocation may remain unused and/or in an idle state. Further, if the estimated length of the time includes an underestimated length of the time compared to the actual runtime, then the performance of the workload may not be completed and/or may be terminated after the estimated length of the time has elapsed. As a result, provisioning of desired computer implemented services by the distributed system may be impacted.

In general, embodiments disclosed here relate to systems and methods for managing operation of a distributed system. The operation may be managed by (i) identifying a workload to be performed by the distributed system, (ii) obtaining, using a trained machine learning model, a runtime estimation for performance of the workload, (iii) scheduling, using the runtime estimation and a scheduling algorithm, the performance of the workload during a future period of time to obtain a resource allocation of the distributed system and a time allocation of the distributed system, (iv) attempting, using the resource allocation and the time allocation, to perform the workload, (v) generating, in a first instance of the attempting where the performance of the workload is completed successfully, a first reward for the performance using a first reward generation algorithm, (vi) generating, in a second instance of the attempting where the performance of the workload is not completed successfully, a second reward for the performance using a second reward generation algorithm, and/or (vii) using the first reward and/or the second reward to update the operation of the trained machine learning model to reduce a likelihood of underestimates for runtime estimations being made at future times.

The workload may be identified by (i) receiving a workload request from a client and/or (ii) generating, using the workload request, a workload to be performed on the distributed system. The workload may be generated by reading, by a management system, the workload request and/or generating, by the management system, at least one task of the workload based on any portion of the workload request.

The runtime estimation for the performance of the workload may be obtained by performing a search of historical workloads to obtain the runtime estimation from the historical workloads. The runtime estimation may include a first length of time for how long the performance of the workload can take. The historical workloads may be stored in a repository of the distributed system. The repository may include (i) historical runtime estimations, (ii) actual runtimes after completion of performances of the historical workloads, (iii) input data of the historical workloads, etc.

Based on results of the search of the historical workloads, the trained machine learning model may generate the runtime estimation. The trained machine learning model may include (i) Deep-Q networks (DWN), (ii) actor-critic models, (iii) soft actor-critic models, (iv) twin-delayed deep deterministic policy gradient (TD3) models, etc. The trained machine learning model may be adapted to generate the runtime estimations. Further, the trained machine learning model may utilize weights, biases, and/or gradients.

The performance of the workload may be scheduled by transmitting the workload to a queue hosted by a scheduling algorithm of the management system of the distributed system. The queue may include at least one future period of the time (e.g., a future date and/or a future time) during which the performance of the workload may take place. Further, the scheduling algorithm may assign the performance of the workload to at least one data processing system. Before and/or after the transmission and based the runtime estimation, the scheduling algorithm may provision a resource allocation and/or a time allocation for the resources of the resource allocation. The resources may include (i) available CPU, (ii) available GPUs, (iii) available memory, etc. The time allocation may include a second length of time during which the resources are allocated for the performance of the workload.

The workload may be attempted to be performed, using the resource allocation and/or the time allocation and/or by the at least one data processing system, by performing at least one task of the workload. The at least one task may be related to (i) data processing, (ii) distributed simulations, (iii) hosted applications, (iv) financial transactions, etc. The performance may include performing, by the at least one data processing system, a process by the at least one task.

In the first instance of the attempting where the performance of the workload is completed successfully, the first reward may be generated by performing, using the runtime estimation and/or a first actual time for completion of the performance of the workload, a first computation. The first computation may include ingestion of the runtime estimation and/or the first actual time for the completion into a first expression. The first expression may be designed such that the first reward varies inversely with a first difference between the runtime estimation and the first actual runtime. The first expression may be used when the runtime estimation is not less than the first actual runtime (i.e., the runtime estimation is a match and/or is an overestimate the first actual runtime).

In the second instance of the attempting where the performance of the workload is not completed successfully, the second reward may be generated by performing using the runtime estimation and/or a second actual time, a second computation. The second actual time may be obtained because the runtime estimation is an underestimate of the performance of the workload and/or therefore the performance is terminated by the distributed system. The second computation may include the ingestion of the runtime estimation and/or the second actual time for the completion into a second expression. The second expression may be designed such that the second reward varies inversely with a second difference between the runtime estimation and the second actual runtime. The second expression may be used when the runtime estimation is less than the second actual runtime (i.e., the runtime estimation is an underestimate the second actual runtime).

The first reward and/or the second reward may be used to update the operation of the trained machine learning model by adjusting, based on the first reward and/or the second reward, the weights, the biases, and/or the gradients of the trained machine learning model. The adjustments may be performed to enforce future generations, by the trained machine learning model, of future runtime estimations that best match future actual runtime of future performances of future workloads. By enforcing the future generations of the future runtime estimations, the future performances of the future workloads may be completed and/or the distributed system may facilitate a provisioning of desired computer implemented services.

To provide the above noted functionality, the system may include a management system (e.g., 100) and data processing systems (e.g., 104). Each of these components is discussed below.

The data processing systems (e.g., 104) may include any number of the data processing systems (e.g., 104A-104N). A first portion of the data processing systems (e.g., 104) may host client systems. A client of the client systems may include (i) a user, (ii) an administrator, etc. A second portion of the data processing systems (e.g., 104) may be used to perform a workload. To perform the workload, the any number of the data processing systems (e.g., 104A-104N) may perform at least one task of the workload.

The management system (e.g., 100) may host a scheduling algorithm and/or may utilize a trained machine learning model. The management system (e.g., 100) may receive the request for the workload and/or use the request to generate a list of at least task of the workload. Once the at least one task has been generated, the scheduling algorithm may (i) assign the workload to a queue, (ii) receive, from the trained machine learning model, a runtime estimation for the workload, (iii) determine a resource allocation and/or a time allocation of the resource allocation, and/or (iv) assign at least one of the any number of the data processing systems (e.g., 104A-104N) to perform the workload.

The trained machine learning model may include (i) Deep-Q networks (DWN), (ii) actor-critic models, (iii) soft actor-critic models, (iv) twin-delayed deep deterministic policy gradient (TD3) models, etc. The trained machine learning model may be adapted to generate the runtime estimations. Further, the trained machine learning model may utilize weights, biases, and/or gradients. The trained machine learning model may ingest historical workloads from a repository of the management system (e.g., 100) and/or use any portion of the historical workloads to generate the runtime estimation.

Based the runtime estimation, the workload may either be successfully completed and/or may be prematurely terminated by the distributed system. If the workload is successfully completed, a first computation may be performed to generate a first reward. The first computation may be used because the runtime estimation is an overestimated length of time and/or a matching length of time compared to an actual time for completion of the workload. The management system (e.g., 100) may perform the first computation.

If the workload is not completed and/or is terminated, a second computation may be performed to generate a second reward. The second computation may be used because the runtime estimation is an underestimated length of time compared to the actual time for completion of the workload. The management system (e.g., 100) may perform the second computation.

Based on the first reward and/or second reward, the management system (e.g., 100) may update operation of the trained machine learning model by performing a modification to the weights, the biases, and/or the gradients of the trained machine learning model to generate an updated trained machine learning model. The updated trained machine learning model may be used by the management system (e.g., 100) to perform future runtime estimations of future performances of future workloads.

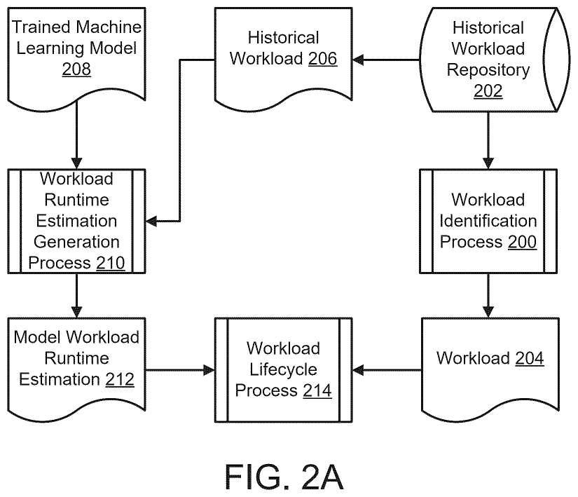

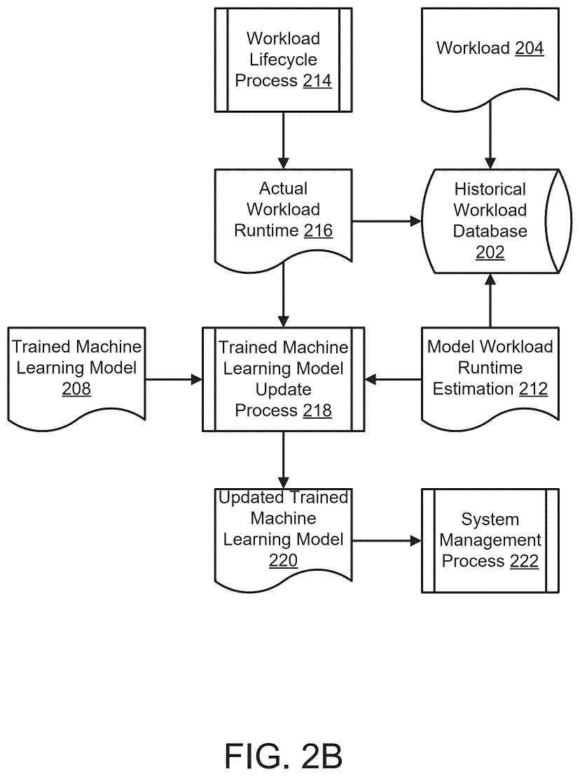

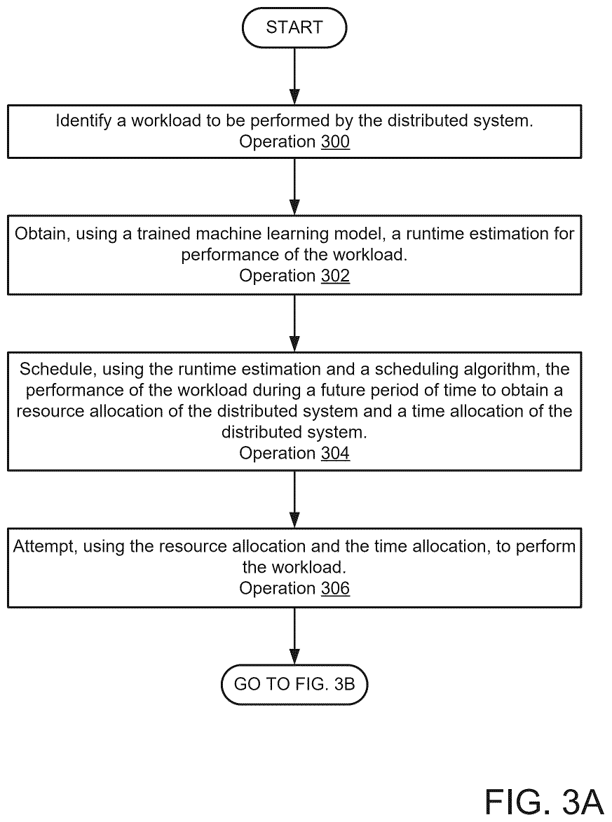

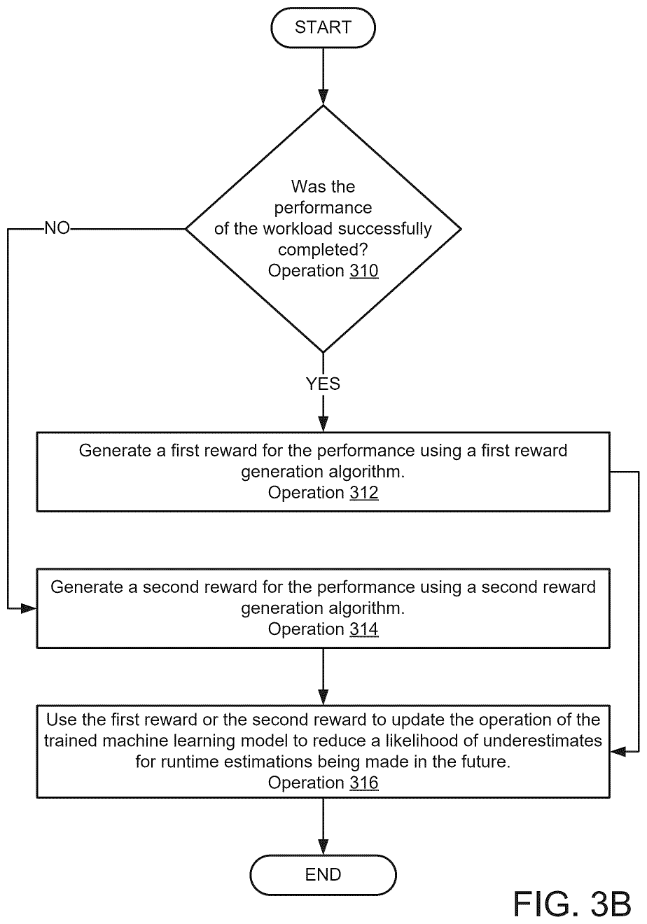

While providing their functionality, any of the management system (e.g., 100) and the data processing systems (e.g., 104) may perform all, or a portion, of the flows and methods shown in FIGS. 2A-3B.

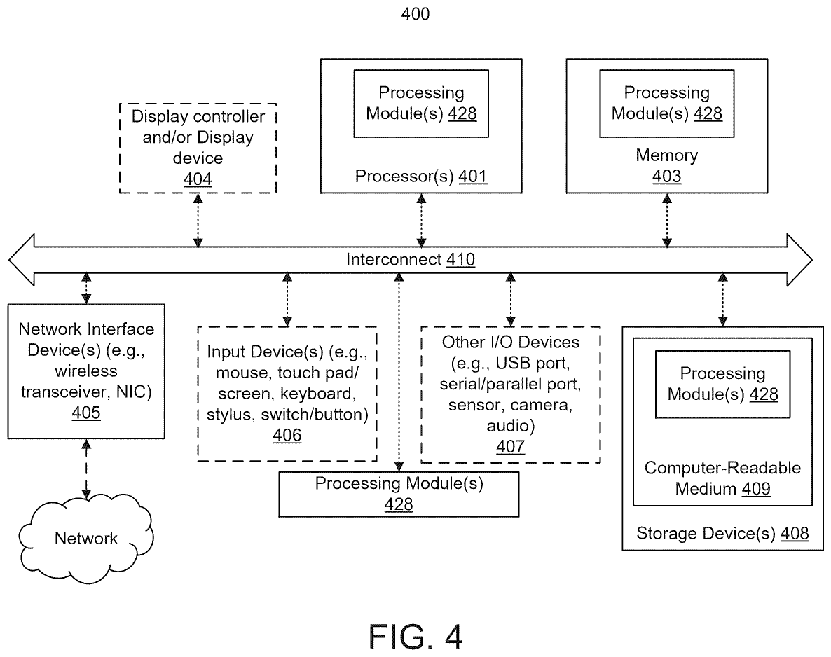

Any of (and/or components thereof) the management system (e.g., 100) and the data processing systems (e.g., 104) may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with the communication system (e.g., 102). In an embodiment, the communication system (e.g., 102) includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 206, 208, etc.) is used to represent data structures, a second set of shapes (e.g., 200, 210, etc.) is used to represent processes performed using and/or that generate data, and a third set of shapes (e.g., 202, etc.) is used to represent large scale data structures such as databases.

Turning to FIG. 2A, a first data flow diagram in accordance with an embodiment is shown. The first data flow diagram may illustrate data used in and data processing performed in performing a workload lifecycle process (e.g., 214).

To perform the workload lifecycle process (e.g., 214), a workload identification process (e.g., 200) may be performed. During the workload identification process, (e.g., 200), a workload (e.g., 204) may be identified. The workload (e.g., 204) may be identified by (i) receiving a workload request from a client and/or (ii) generating, using the workload request, the workload (e.g., 204) to be performed on the distributed system. The workload (e.g., 204) may be generated by reading, by a management system (e.g., 100), the workload request and/or generating, by the management system (e.g., 100), at least one task of the workload (e.g., 204) based on any portion of the workload request.

The workload (e.g., 204) may include the at least one task that can be performed by any number of data processing systems (e.g., 104A-104N). The workload (e.g., 204) may further include (i) input data that can be processed by the any number of data processing systems (e.g., 104A-104N), (ii) processing instructions for the any number of data processing systems (e.g., 104A-104N), (iii) references to dependencies (e.g., (a) libraries, (b) databases, (c) external resources, and/or (d) any other references to other dependencies), (iv) metadata from the client, (e) data processing system settings (e.g., (a) memory limits, (b) security protocols, (c) error-handling preferences, and/or (d) any other data processing system settings), etc.

Any portion of the workload (e.g., 204) may be configured using historical workloads from a historical workload repository (e.g., 202). The historical workload repository (e.g., 202) may include (i) workload execution details (e.g., (a) an actual runtime to completion of historical performances of the historical workloads, (b) an estimated runtime to completion of the historical performances of the historical workloads, (c) success rates, (d) failure rates, (e) first identifications of previously assigned data processing systems, and/or (f) any other workload execution details), (ii) resource allocation metrics (e.g., (a) CPU, (b) memory, (c) network bandwidth consumption, (d) second identifications of clients who requested the historical performances of the historical workloads, and/or (e) any other resource allocation metrics), (iii) historical workload patterns (e.g., (a) periodic historical workload trends, (b) predictive analyses based on the periodic historical workload trends, and/or (c) any other historical workload patterns), etc.

From the historical workload repository (e.g., 202), a historical workload (e.g., 206) may be obtained. The historical workload (e.g., 206) may be obtained by performing, using the any portion of the workload (e.g., 204), a search for the historical workload (e.g., 206). Because the search using the workload (e.g., 204) is used to obtain the historical workload (e.g., 206), a portion of the workload (e.g., 204) may be similar to the historical workload (e.g., 206). The portion that is be similar may include (i) the at least one task, (ii) the input data, (iii) the processing instructions, (iv) the references to the dependencies, and/or (v) any other portion of the workload (e.g., 204).

Using the historical workload (e.g., 206) and/or a trained machine learning model (e.g., 208), a workload runtime estimation generation process (e.g., 210) may be performed. To perform the workload runtime estimation generation process (e.g., 210), the trained machine learning model (e.g., 208) may ingest the historical workload (e.g., 206) and/or generate a model workload runtime estimation (e.g., 212).

The trained machine learning model (e.g., 208) may include (i) Deep-Q networks (DWN), (ii) actor-critic models, (iii) soft actor-critic models, (iv) twin-delayed deep deterministic policy gradient (TD3) models, etc. The trained machine learning model (e.g., 208) may be adapted to generate the runtime estimations. Further, the trained machine learning model (e.g., 208) may utilize weights, biases, and/or gradients.

The model workload runtime estimation (e.g., 212) may include a length of time indicating when the performance of the workload (e.g., 204) is expected to be completed. The model workload runtime estimation (e.g., 212) may be generated by the trained machine learning model (e.g., 208) and/or may be based on (i) the portion of the historical workload (e.g., 206) that is similar to the workload (e.g., 204), (ii) an expected resource allocation, (iii) any parallel processing that can occur between the any number of the data processing systems (e.g., 104A-104N), etc.

Using the workload (e.g., 204) and/or the model workload runtime estimation (e.g., 212), a workload lifecycle process (e.g., 214) may be performed. During the workload lifecycle process (e.g., 214), (i) the workload (e.g., 204) may be submitted to a scheduling algorithm of the management system (e.g., 100), (ii) the scheduling algorithm may generate a resource allocation and/or a time allocation for performance of the workload (e.g., 204), (iii) the scheduling algorithm may assign the performance of the workload (e.g., 204) to the any number of the data processing systems (e.g., 104A-104N), (iv) the any number of the data processing systems (e.g., 104A-104N) may initiate the performance of the workload (e.g., 204), (v) an actual runtime (e.g., a second length of the time) during which the any number of the data processing systems (e.g., 104A-104N) may complete the performance of the workload (e.g., 204), and/or (vii) tracked data (e.g., (a) performance metrics, (b) the actual runtime of the performance of the workload (e.g., 204), (c) the model workload runtime estimation (e.g., 212), and/or (d) any other tracked data) may be transmitted from the any number of the data processing systems (e.g., 104A-104N) to the management system (e.g., 100).

The resource allocation may include resources such as (i) available CPU, (ii) available GPUs, (iii) available memory, and/or (iv) any other resources of the distributed system. The time allocation may include a third length of time for the resource allocation. The performance metrics may include (i) CPU consumption, (ii) GPU consumption, (iii) memory consumption, (iv) network bandwidth consumption, (v) an actual time elapsed per the at least one task, (vi) error rates, etc. Given that the trained machine learning model (e.g., 208) generated the model workload runtime estimate (e.g., 212), the model workload runtime estimate (e.g., 212) may be an overestimate, a match, and/or an underestimate of the actual runtime. If the model workload runtime estimate (e.g., 212) is an overestimate and/or a match of the actual runtime, then the performance of the workload (e.g., 204) may be completed by the any number of the data processing systems (e.g., 104A-104N). Otherwise, if the model workload runtime estimate (e.g., 212) is an underestimate of the actual runtime, then the performance of the workload (e.g., 204) may not be completed and/or may be terminated by the any number of the data processing systems (e.g., 104A-104N).

Thus, via the first data flow illustrated in FIG. 2A, a system in accordance with an embodiment may perform the workload lifecycle process (e.g., 214) using the model workload runtime estimation (e.g., 212). Consequently, the distributed system may be more likely to be able to provide desired computer implemented services by using the model workload runtime estimation (e.g., 212) generated by the trained machine learning model (e.g., 208) for the performance of the workload lifecycle process (e.g., 214).

Turning to FIG. 2B, a second data flow diagram in accordance with an embodiment is shown. The second data flow diagram may illustrate data used in and data processing performed in performing a system management process (e.g., 222).

To perform the system management process (e.g., 222), performance of a workload lifecycle process (e.g., 214) may be completed. From the workload lifecycle process (e.g., 214), an actual workload runtime (e.g., 216) may be obtained from a management system (e.g., 100) of the distributed system.

The actual workload runtime (e.g., 216) may include an actual runtime (e.g., the second length of time described in the description of FIG. 2A) of the performance of the workload (e.g., 204 from the description of FIG. 2A). The actual workload runtime (e.g., 216) may be included with performance metrics provided from output data from any number of data processing systems (e.g., 104A-104N) from the workload lifecycle process (e.g., 214, from the description of FIG. 2A).

The actual workload runtime (e.g., 216), the workload (e.g., 204), and a model workload runtime estimation (e.g., 212, from the description of FIG. 2A) may be stored in a historical workload database (e.g., 202) by the management system (e.g., 100). The historical workload database (e.g., 202) is detailed in the description of FIG. 2A.

The actual workload runtime (e.g., 216), the model workload runtime estimation (e.g., 212), and/or a trained machine learning model (e.g., 208) may be used to perform a trained machine learning model update process (e.g., 218). The trained machine learning model (e.g., 208) is detailed in the description of FIG. 2A.

During the trained machine learning model update process (e.g., 218), the actual workload runtime (e.g., 216) and/or the model workload runtime estimation (e.g., 212) may be used to generate a first reward and/or a second reward.

In the first instance of the attempting where the performance of the workload (e.g., 204) is completed successfully, the first reward may be generated by performing, using the model workload runtime estimation (e.g., 212) and/or the actual workload runtime (e.g., 216), a first computation. The first computation may include ingestion of the model workload runtime estimation (e.g., 212) and/or the actual workload runtime (e.g., 216) for the completion into a first expression. The first expression may be designed such that the first reward varies inversely with a first difference between the model workload runtime estimation (e.g., 212) and/or the actual workload runtime (e.g., 216). The first expression may be used when the model workload runtime estimation (e.g., 212) is not less than the actual workload runtime (e.g., 216) or, in other words, the model workload runtime estimation (e.g., 212) is a match and/or is an overestimate of the actual workload runtime (e.g., 216). As the model workload runtime estimation (e.g., 212) approaches the actual workload runtime (e.g., 216) to match, the first reward may increase.

In the second instance of the attempting where the performance of the workload is not completed successfully, the second reward may be generated by performing, using the model workload runtime estimation (e.g., 212) and/or the actual workload runtime (e.g., 216), a second computation. The model workload runtime estimation (e.g., 212) may include an underestimate and/or not a match of the actual workload runtime (e.g., 216. As a result, the performance of the workload may not be completed and/or may be terminated by the distributed system. The second computation may include the ingestion of the model workload runtime estimation (e.g., 212) and/or the actual workload runtime (e.g., 216) into a second expression. The second expression may be designed such that the second reward varies inversely with a second difference between the model workload runtime estimation (e.g., 212) and/or the actual workload runtime (e.g., 216). The second expression may be used when the model workload runtime estimation (e.g., 212) is less than the actual workload runtime (e.g., 216) (i.e., the model workload runtime estimation (e.g., 212) is an underestimate of the actual workload runtime (e.g., 216)). As the model workload runtime estimation (e.g., 212) diverges from the actual workload runtime (e.g., 216) to a larger underestimate, the second reward may decrease.

Further, during the trained machine learning model update process (e.g., 218), the first reward and/or the second reward may be used to generate an updated trained machine learning model (e.g., 220). The updated trained machine learning model (e.g., 220) may be generated by ingesting, by the trained machine learning model (e.g., 220), the first reward and/or the second reward and/or using the first reward and/or the second reward to update operation of the trained machine learning model (e.g., 208). The operation may be updated by adjusting, based on the first reward and/or the second reward, weights, biases, and/or gradients of the trained machine learning model (e.g., 208) to generate the updated trained machine learning model (e.g., 220).

Finally, using the updated trained machine learning model (e.g., 220), the system management process (e.g., 222) may be performed. During the system management process (e.g., 222), a future workload (e.g., similar and/or different to 204) may be received by the distributed system. The updated trained machine learning model (e.g., 220) may, using a historical workload (e.g., 206, from the description of FIG. 2A and/or which in this case can be similar to 204, as 204 is being stored in 202), be used to generate a future model workload runtime estimation (e.g., similar and/or different than 212 from the description of FIG. 2A).

The future model workload runtime estimation and/or the future workload may be used to perform a future workload lifecycle process (e.g., similar and/or different to 214, which is detailed in the description of FIG. 2A). During the future workload lifecycle process, the future model workload runtime estimation may more likely match a future actual workload runtime (e.g., similar and/or different to 216). As the future model workload runtime estimation may more likely match, performance of the future workload by the any number of the data processing systems (e.g., 104A-104N) may improve a likelihood of successfully completing the performance of the future workload and/or not terminating the performance of the future workload.

Thus, via the second data flow illustrated in FIG. 2A, a system in accordance with an embodiment may perform the system management process (e.g., 222). Consequently, the distributed system may be more likely to be able to provide desired computer implemented services by improving the likelihood of completion of the performance of the future workload.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage operation of a distributed system. FIGS. 3A-3B illustrate a method that may be performed by the components of the system of FIG. 1. In the diagram discussed below and shown in FIGS. 3A-3B, any of the operations may be repeated, performed in different orders, and/or performed in parallel with or in a partially overlapping in time manner with other operations.

Turning to FIGS. 3A-3B, a flow diagram illustrating a method of managing the operation of the distributed system in accordance with an embodiment is shown. The method may be performed, for example, by any of the components of the system of FIG. 1, and/or other components not shown therein.

At operation 300, a workload may be identified to be performed by the distributed system. The workload may be identified by (i) receiving a workload request from a client and/or (ii) generating, using the workload request, the workload to be performed on the distributed system. The workload may be generated by reading, by a management system, the workload request and/or generating, by the management system at least one task of the workload based on any portion of the workload request.

At operation 302, a runtime estimation for performance of the workload may be obtained by performing a lookup of past performances of historical workloads to obtain the runtime estimation from the past performances of the historical workloads. The lookup may be performed by comparing the historical workloads to the workload. Specifically, the comparison may include correlating (i) resources consumed, (ii) any number of data processing systems used to perform the historical workloads, and/or (iii) any other detail of the historical workloads to obtain the runtime estimation.

At operation 304, the performance of the workload during a future period of time may be scheduled using the runtime estimation and a scheduling algorithm to obtain a resource allocation of the distributed system and a time allocation of the distributed system. The performance of the workload may be scheduled by receiving, by the scheduling algorithm, the workload and/or obtaining, by the scheduling algorithm and/or based on the runtime estimation, the resource allocation and/or the time allocation.

At operation 306, the workload may be attempted to be performed using the resource allocation and the time allocation. The workload may be attempted to be performed by transmitting the workload to the any number of the data processing systems and/or providing the resource allocation and/or the time allocation to the any number of the data processing systems for the performance of the workload.

Continuing on to FIG. 3B, at operation 310, a determination may be made whether the performance of the workload successfully completed. The determination may be made by reading an output of the any number of the data processing systems once the performance of the workload has stopped.

If, in a first instance of the determination, the performance of the workload completed successfully, then the method may continue at operation 312. Otherwise, if, in a second instance of the determination, the performance of the workload did not complete successfully, then the method may continue at operation 314.

Continuing from operation 310, at operation 312, a first reward may be generated for the performance using a first reward generation algorithm. The first reward may be generated by performing a first computation to generate the first reward using (i) the runtime estimation, (ii) a first actual runtime for the completion of the performance of the workload, and (iii) a first expression that causes the first reward to vary inversely with a first difference between the runtime estimation and the first actual runtime, the runtime estimation not being less than the first actual runtime. The first computation may be performed by ingesting, by the first expression, at least the runtime estimation and/or the first actual runtime to generate the first reward.

Continuing from operation 310, at operation 314, a second reward may be generated for the performance using a second reward generation algorithm. The second reward may be generated by performing a second computation to generate the second reward using (i) the runtime estimation, (ii) a second actual runtime, and (iii) a second expression that causes the second reward to vary inversely with a second difference between the runtime estimation and the second actual runtime, the runtime estimation being less than the second actual runtime. The second computation may be performed by ingesting, by the second expression, at least the runtime estimation and/or the second actual runtime to generate the second reward.

Continuing from either operation 312 and/or operation 314, at operation 316, the first reward or the second reward may be used to update the operation of the trained machine learning model to reduce a likelihood of underestimates for runtime estimations being made in the future. The first reward or the second reward may be used by performing, using the first reward or the second reward, adjustments to weights, biases, and/or gradients of the trained machine learning model. The adjustments may be performed by modifying the weights, the biases, and/or the gradients of the trained machine learning model to cause variations in a future first reward, compared to the first reward, and/or a future second reward, compared to the second reward, the future first reward and/or the future second reward being associated with future workloads.

The first reward or the second reward may further be used by performing at least one change to an action space of the trained machine learning model on which a determination of the runtime estimation is based. The at least one change may be performed by adding and/or removing at least one variable of the action space that is used to generate, by the trained machine learning model, a future runtime estimation. The at least one variable may include (i) at least one resource that is consumed, (ii) at least one of the any number of the data processing systems that carry out the performance of a future workload, etc.

The method may end following operation 316.

Thus, via the method shown in FIGS. 3A-3B, embodiments herein may likely improve a likelihood of managing the operation of the distributed system. By improving the likelihood of managing the operation of the distributed system, the distributed system may be more likely to provide desirable computer implemented services by, for example, generating runtime estimations using the trained machine learning model, using the first reward and/or the second reward to update the operation of the trained machine learning model to improve generation of future runtime estimations, etc.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a distributed system, the method comprising:
identifying a workload to be performed by the distributed system;
obtaining, using a trained machine learning model, a runtime estimation for performance of the workload;
scheduling, using the runtime estimation and a scheduling algorithm, the performance of the workload during a future period of time to obtain a resource allocation of the distributed system and a time allocation of the distributed system;
attempting, using the resource allocation and the time allocation, to perform the workload;
in a first instance of the attempting where the performance of the workload is completed successfully:
generating a first reward for the performance using a first reward generation algorithm;
in a second instance of the attempting where the performance of the workload is not completed successfully:
generating a second reward for the performance using a second reward generation algorithm; and
using the first reward or the second reward to update the operation of the trained machine learning model to reduce a likelihood of underestimates for runtime estimations being made at future times.

2. The method of claim 1, wherein the distributed system comprises a plurality of data processing systems for performing workloads, the plurality of data processing systems being managed using a scheduling system that limits use of resource allocations of the data processing systems for respective performances of the workloads, and the scheduling system terminating use of the resource allocations for the performances of the workloads regardless of whether the workloads are complete when corresponding time allocations for the resource allocations are exceeded.

3. The method of claim 1, wherein obtaining, using the trained machine learning model, the runtime estimation comprises:
performing a lookup of past performances of historical workloads to obtain the runtime estimation from the past performances of the historical workloads.

4. The method of claim 1, wherein generating the first reward comprises:
performing a first computation to generate the first reward using:
the runtime estimation,
a first actual runtime for the completion of the performance of the workload, and
a first expression that causes the first reward to vary inversely with a first difference between the runtime estimation and the first actual runtime, the runtime estimation not being less than the first actual runtime.

5. The method of claim 4, wherein generating the second reward comprises:
performing a second computation to generate the second reward using:
the runtime estimation,
a second actual runtime, and
a second expression that causes the second reward to vary inversely with a second difference between the runtime estimation and the second actual runtime, the runtime estimation being less than the second actual runtime.

6. The method of claim 5, wherein using the first reward or the second reward to update the operation of the trained machine learning model comprises:
performing, using the first reward or the second reward, adjustments to weights, biases, and/or gradients of the trained machine learning model.

7. The method of claim 6, wherein the adjustments are used, using the first reward, to enforce generation of future runtime estimations that are not less than the first actual runtime.

8. The method of claim 7, wherein the adjustments are further used, using the second reward, to enforce the generation of the future runtime estimations that are greater than the second actual runtime.

9. The method of claim 8, wherein using the first reward or the second reward to update the operation of the trained machine learning model further comprises:
performing at least one change to an action space of the trained machine learning model on which a determination of the runtime estimation is based.

10. The method of claim 9, wherein the action space comprises a portion of the workload, the portion comprising input data for performance of the workload, at least one task of the workload, and/or an output data of the workload.

11. A non-transitory machine-readable medium having instructions stored therein, which when executed by a processor, cause the processor to perform operations for managing operation of a distributed system, the operations comprising:
identifying a workload to be performed by the distributed system;
obtaining, using a trained machine learning model, a runtime estimation for performance of the workload;
scheduling, using the runtime estimation and a scheduling algorithm, the performance of the workload during a future period of time to obtain a resource allocation of the distributed system and a time allocation of the distributed system;
attempting, using the resource allocation and the time allocation, to perform the workload;
in a first instance of the attempting where the performance of the workload is completed successfully:
generating a first reward for the performance using a first reward generation algorithm;
in a second instance of the attempting where the performance of the workload is not completed successfully:
generating a second reward for the performance using a second reward generation algorithm; and
using the first reward or the second reward to update the operation of the trained machine learning model to reduce a likelihood of underestimates for runtime estimations being made at future times.

12. The non-transitory machine-readable medium of claim 11, wherein the distributed system comprises a plurality of data processing systems for performing workloads, the plurality of data processing systems being managed using a scheduling system that limits use of resource allocations of the data processing systems for respective performances of the workloads, and the scheduling system terminating use of the resource allocations for the performances of the workloads regardless of whether the workloads are complete when corresponding time allocations for the resource allocations are exceeded.

13. The non-transitory machine-readable medium of claim 11, wherein obtaining, using the trained machine learning model, the runtime estimation comprises:
performing a lookup of past performances of historical workloads to obtain the runtime estimation from the past performances of the historical workloads.

14. The non-transitory machine-readable medium of claim 11, wherein generating the first reward comprises:
performing a first computation to generate the first reward using:
the runtime estimation,
a first actual runtime for the completion of the performance of the workload, and
a first expression that causes the first reward to vary inversely with a first difference between the runtime estimation and the first actual runtime, the runtime estimation not being less than the first actual runtime.

15. The non-transitory machine-readable medium of claim 14, wherein generating the second reward comprises:
performing a second computation to generate the second reward using:
the runtime estimation,
a second actual runtime, and
a second expression that causes the second reward to vary inversely with a second difference between the runtime estimation and the second actual runtime, the runtime estimation being less than the second actual runtime.

16. A data processing system, comprising:
a processor; and
a memory coupled to the processor to store instructions, which when executed by the processor, cause the processor to perform operations managing operation of a distributed system, the operations comprising:
identifying a workload to be performed by the distributed system;
obtaining, using a trained machine learning model, a runtime estimation for performance of the workload;
scheduling, using the runtime estimation and a scheduling algorithm, the performance of the workload during a future period of time to obtain a resource allocation of the distributed system and a time allocation of the distributed system;
attempting, using the resource allocation and the time allocation, to perform the workload;
in a first instance of the attempting where the performance of the workload is completed successfully:
generating a first reward for the performance using a first reward generation algorithm;
in a second instance of the attempting where the performance of the workload is not completed successfully:
generating a second reward for the performance using a second reward generation algorithm; and
using the first reward or the second reward to update the operation of the trained machine learning model to reduce a likelihood of underestimates for runtime estimations being made at future times.

17. The data processing system of claim 16, wherein the distributed system comprises a plurality of data processing systems for performing workloads, the plurality of data processing systems being managed using a scheduling system that limits use of resource allocations of the data processing systems for respective performances of the workloads, and the scheduling system terminating use of the resource allocations for the performances of the workloads regardless of whether the workloads are complete when corresponding time allocations for the resource allocations are exceeded.

18. The data processing system of claim 16, wherein obtaining, using the trained machine learning model, the runtime estimation comprises:
performing a lookup of past performances of historical workloads to obtain the runtime estimation from the past performances of the historical workloads.

19. The data processing system of claim 16, wherein generating the first reward comprises:
performing a first computation to generate the first reward using:
the runtime estimation,
a first actual runtime for the completion of the performance of the workload, and
a first expression that causes the first reward to vary inversely with a first difference between the runtime estimation and the first actual runtime, the runtime estimation not being less than the first actual runtime.

20. The data processing system of claim 19, wherein generating the second reward comprises:
performing a second computation to generate the second reward using:
the runtime estimation,
a second actual runtime, and
a second expression that causes the second reward to vary inversely with a second difference between the runtime estimation and the second actual runtime, the runtime estimation being less than the second actual runtime.
